(19) United States
(12) Patent Application Publication
(10) Pub. No.: US 2007/0158923 A1
(43) Pub. Date: Jul. 12, 2007

(54) UNIT STRUCTURE FOR A CONTAINER

(76) Inventor: Jing-Ru Chen, Tachia Chen (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/306,792

(22) Filed: Jan. 11, 2006

(51) Int. Cl. B62B 3/00

(52) U.S. Cl. 280/47.34

(57) ABSTRACT

A unit structure for a container comprising a base, a cover and a supporting board; the base including a left wall, a right wall, a rear wall, an upper surface and a lower surface. The connecting place between an upper edge of the said three walls and a peripheral of the upper surface forming a hole respectively; and a female linking tape is defined in the connection of the respective hole and the upper surface; the connecting place between a lower edge of the said three walls and a peripheral of the lower surface forming a male linking tape respectively, and the male linking tapes that are opposite to the holes and the female linking tape respectively. The cover is a board with a handle thereof, the lower edge of the cover is connected with the front edge of the lower surface. The supporting board is bended to form a □-shaped member for putting into the base. By such arrangement, a multi-layer container is formed by connecting the linking tapes, and several wheels are formed in the bottom of the lowest container in order to facilitate the moving of the multi-layer container.

### BACKGROUND OF THE INVENTION

1. Field of the Invention

The present invention relates to a unit structure for a container, and more particularly to a unit structure for a container which can be superposed to form a multi-layer container, which the upper container can be engaged with the under container by several fastening tapes so as to form a multi-layer container. Furthermore, the bottom of last under container can be mounted wheels so that the user can move the multi-layer containers easily.

2. Description of the Prior Art

The container for collecting stuffs is one necessary article in our life. Except for the wooden or plastic container which is formed fixedly, the conventional container made by canvas which can be dismantled to reduce the volume when it is not used and has support for its four walls when it is expended is one kind of popular containers on the market Such container can be used flexibly, and it has the advantage for being dismantled so as to reduce the volume and space when it is not used. However, the superposed containers cannot be engaged fixedly with each other so that it is not steady for the containers which are superposed highly, thereby the conventional invention is not convenience.

The present invention has arisen to mitigate and/or obviate the afore-described disadvantages.

### SUMMARY OF THE INVENTION

The primary objective of the present invention is to provide a unit structure for a container which the upper container can be engaged with the under container by several fastening tapes so as to form a multi-layer container. Furthermore, the bottom of last under container can be mounted wheels so that the user can move the multi-layer containers easily.

The present invention is made for solving the conventional problem of prior art. The further objective of the present invention is to provide a unit structure for a container, which comprising a base, a lid and a supporting board. The base is stitched up with a left wall, a right wall, a rear wall, an upper plane and a lower plane. A penetrated hole is formed in every joint of the left wall, right wall, the upper edge of the rear wall and the edge of the upper plane. The female fastening tapes are stitched on the upper surface of the penetrated hole. The male fastening tapes are stitched on the joint of left wall, right wall, the under edge of the rear wall and the edge of the lower plane by the position corresponding to female fastening tape. The lid is a board with a handle thereof, the lower end of the handle is stitched with the front edge of the lower plane of the base. The supporting board can be bended to form a □-shaped member and put into the base.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a unit structure for a container in accordance with the present invention;

FIG. 2 is a perspective view of the unit structure for a container taken along line A-A;

FIG. 3 is an exploded view of the unit structure for a container in accordance with the present invention;

FIG. 4 is an assembly view of the unit structure for a container in accordance with the present invention;

FIG. 5 is a perspective view of a multi-layer container in accordance with the present invention; and

FIG. 6 is a perspective view of the unit structure for a container taken along line B-B.

### DETAILED DESCRIPTION OF THE PREFERRED EMBODIMENTS

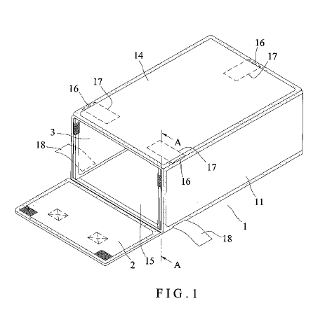

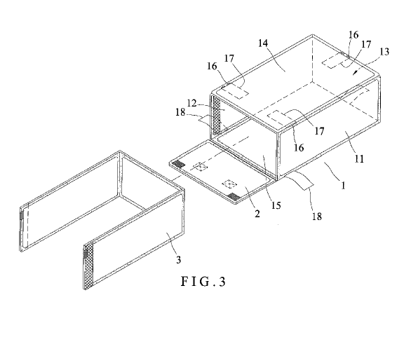

Referring to FIGS. 1-3, a unit structure for a container in accordance with the present invention is comprises a base 1, a lid 2 and a supporting board 3.

The base 1 is a hollow member that is stitched with a left wall 11, a right wall 12, a rear wall 13, an upper plane 14 and a lower plane 15. A penetrated hole 16 is formed in every joint of the left wall 11, right wall 12, the upper edge of the rear wall 13 and the edge of the upper plane 14. The female fastening tapes 17 are stitched on the upper surface of the penetrated hole 16. The male fastening tapes 18 are stitched on the joint of left wall 11, right wall 12, the under edge of the rear wall 13 and the edge of the lower plane 15 by the position corresponding to female fastening tape 17.

The lid 2 is a board with a handle 21 thereof, the lower end of the handle 21 is stitched with the front edge of the lower plane 15 of the base 1.

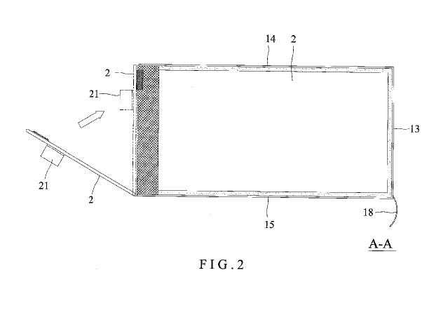

The supporting board 3 can be bended to form a □-shaped member and put into the base 1 as shown in FIG. 2.

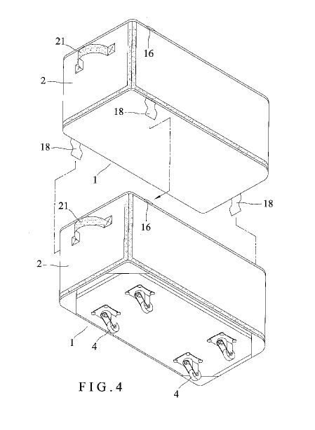

Referring to FIG. 4, several wheels 4 are formed in the bottom of the lowest container in order to facilitate the moving of a multi-layer container.

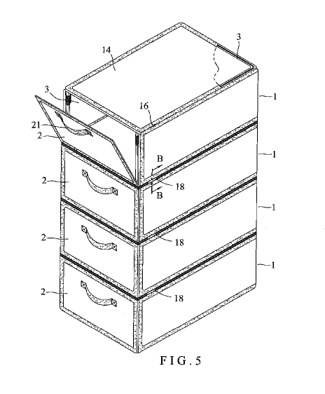

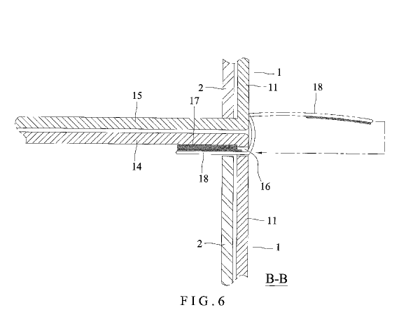

A multi-layer container as shown in FIGS. 4-6, firstly piercing the male fastening tape 18 through the upper base 1 with penetrated hole 16 of the next base 1, and then engaging the respective male fastening tapes 18 and the female fastening tapes 17 for positioning the superposed containers.

The advantages of the present invention are described as follows:

Firstly, the container of the present invention can be superposed to form a multi-layer container, and the superposed containers are positioned by the engaged of the female and male linking tapes 17, 18, and the lowest container can be mounted with several wheels 4 for facilitating the moving of a multi-layer container.

Secondly, the multi-layer container is simply assembled, and the superposed containers are positioned stably.

While we have shown and described various embodiments in accordance with the present invention, it should be clear to those skilled in the art that further embodiments may be made without departing from the scope of the present invention.

What is claimed is:

1. A unit structure for a container comprising a base, a lid and a supporting board; the base including a left wall, a right wall, a rear wall, an upper plane and a lower plane; the lid being a board with a handle thereof, and the lower edge of the lid being stitched on the front edge of the lower plane of the base; and the supporting board with three sections being bended to form a □-shaped member thereof, and the supporting board putting into the base;
on the joint between an upper edge of the said three walls and a edge of the upper surface forming a penetrated hole respectively; and a female fastening tape, which is pierced the respective hole through and the upper surface; the connecting place between a lower edge of the said three walls and a peripheral of the lower surface forming a male linking tape respectively, and the male linking tapes that are opposite to the holes and the female linking tape respectively;
the male linking tape of the upper base, which is connected with the hole of the next base, and then positioned the respective male linking tapes and the female linking tapes for positioning the superpositioned containers.

2. The unit structure for a container comprising a base as claimed in claim 1, wherein several wheels are formed in the bottom of the lowest container in order to facilitate the moving of a multi-layer container.
